(19) United States
(12) Patent Application Publication
(10) Pub. No.: US 2021/0039833 A1
(43) Pub. Date: Feb. 11, 2021

(54) Device that prolongs service life of filter element

(71) Applicant: Wei PENG, Jiangxi Province (CN)

(72) Inventor: Wei PENG, Jiangxi Province (CN)

(21) Appl. No.: 16/924,222

(22) Filed: Jul. 9, 2020

(30) Foreign Application Priority Data
Aug. 9, 2019 (CN) 201921289714.3

(51) Int. Cl. B65D 25/04; B01D 65/08

(52) U.S. Cl. CPC B65D 25/04; B01D 61/025; B01D 65/08

(57) ABSTRACT

A device that prolongs service life of a filter element, including a tank, pipe fittings, and a separation panel connecting two inner opposite sides of the tank; a bottom of the tank has through holes; an inner wall of each through hole is welded with a corresponding pipe fitting; a front surface of the tank has a locking groove; a rear surface of the tank has locking blocks fixedly connected near two opposite side edges thereof. The separation panel can divide a water storage space inside the tank, so that unfiltered water and concentrated water in the tank are separated, therefore, waste water is prevented from being discharged to an unfiltered water tank which otherwise reduce the service life of an RO membrane, and the RO membrane can be prevented from being blocked from outputting water, thereby further prolonging the service life of the RO membrane.

### BACKGROUND OF THE INVENTION

The present invention relates to the technical field of filter element, and more specifically relates to a device that prolongs the service life of a filter element.

A water purifier, also known as water purifying device or water quality purifier, is a water treatment device that provides thorough filtering and purifying of water to obtain the water quality required by its intended use. The water purifier discussed herein refers to the small scale water purifier for household use. The key technique of this kind of water purifier for household use is the use of filtering membrane in the filter element. A prior art filtering membrane is mainly an ultrafiltration member or a RO reverse osmosis membrane. This kind of water purifier for household use can effectively filter rust, sands, stones and plastics, and absorb residue chloride, odor, colors, and chemical agents such as agricultural chemicals from water, and can also filter bacteria, viruses, toxicants, and impurities such as heavy metals. Water purifying technique applied to the technical field of drinking water can soon eliminate the problems caused by non acclimatization, and can effectively solve the problem of localized diseases in many places around the world due to excessive harmful substances in underground water. A water tank of the water purifier is used for storing water to be purified. However, a water tank of the water purifier according to the prior art has some disadvantages during actual use. For example:

In the prior art, in order to minimize the overall size of a countertop water purifier, waste water produced through filtration by the RO membrane will be discharged back to the unfiltered water tank so as to reduce the number of times required to pump water and increase the ratio of waste water. However, such a practice will significantly affect the service life of the RO membrane because the RO membrane may be easily blocked from outputting water, and as a result, the effect of water purification of the water purifier will be seriously lowered, and the service life of the filter element will also be greatly reduced. Therefore, the prior art cannot meet the current demand for water purifier.

### BRIEF SUMMARY OF THE INVENTION

In view of the aforesaid disadvantages now present in the prior art, the present invention provides a device that prolongs the service life of the filter element.

To fulfill the above object, the present invention has the following technical solutions: A device that prolongs service life of a filter element, comprising a tank and pipe fittings; a separation panel is provided to connect two inner opposite sides of the tank by welding the separation panel to the two inner opposite sides of the tank at positions next to a middle part of a length of each of the two inner opposite sides; a bottom side of the tank is provided with through holes each corresponding to a divided water storage space of the tank divided by the separation board; an inner wall of each through hole is welded with a corresponding pipe fitting; a middle part of a front surface of the tank is provided with a locking groove; locking blocks are fixedly connected via bolts near a middle part of two opposite side edges of a rear surface of the tank respectively; a protrusion is fixedly connected via a bolt at a middle part of each of the two side surfaces of the tank.

Preferably, a corner of an inner bottom surface of the tank is welded with an installation frame; an inner periphery of the installation frame defines a rectangular shape; middle portions of two edges of the installation frame are each provided with an opening.

Preferably, a middle part of an inner bottom surface of the tank is welded with a positioning block; the positioning block has a circular disc shape.

Preferably, a sliding groove is provided in an interior portion of an upper part of a wall of each pipe fitting; and the sliding groove has a central axis that coincides with a central axis of the corresponding pipe fitting; a sliding ring is slidably coupled inside the sliding groove; a bottom end of the sliding ring has an inverted T cross sectional shape; a top end of the sliding ring extends out of the sliding groove and is welded with a cover panel; first transmission holes are evenly provided around an outer peripheral surface of the sliding ring; pipes are inserted into respective pipe fittings.

Preferably, a middle part of a bottom surface of the cover panel is welded with a position limiting frame; a bottom end of the position limiting frame has a L cross sectional shape; a height of the position limiting frame is not shorter than a height of the sliding ring; the position limiting frame has an annular shape; an outer periphery of the position limiting frame is slidably coupled to an inner wall of the corresponding pipe fitting; an outer peripheral surface of the position limiting frame is provided with second transmission holes.

Preferably, a first sealing ring and a second sealing ring are adhered around an inner wall and an outer wall respectively of each pipe fitting, and an end surface of the first sealing ring and an end surface of the second sealing ring are in contact with the bottom surface of the cover panel; the first transmission holes define a honeycomb shape; the second transmission holes define a honeycomb shape.

The present invention has the following beneficial effects compared with the prior art:

The present invention is provided with a separation panel inside the tank; the separation panel can effectively divide a water storage space inside the tank, so that unfiltered water and concentrated water stored in the tank are separated, and as a result, during purification of water through an RO membrane inside a water purifier, waste water is effectively prevented from being discharged to an unfiltered water tank which otherwise will reduce service life of the RO membrane, and the RO membrane can be effectively prevented from being blocked from outputting water; therefore, the service life of the RO membrane can be further lengthened effectively. Also, pipes are mounted through the pipe fittings at the through holes of the tank; when the pipes are disengaged from the pipe fittings, the cover panels can effectively seal the pipe fittings by moving the cover panels against the pipe fittings via the sliding rings, and a sealing effect is achieved between the cover panels and the pipe fittings via the first sealing rings and the second sealing rings, thereby conveniently facilitating users to dismount and take away the tank full of water without the water leaking out from the tank; as a result, user's experience of dismounting the tank for maintenance is effectively upgraded, thereby effectively overcoming the disadvantages now present in the prior art.

### BRIEF DESCRIPTION OF THE DRAWINGS

FIG. 1 is a sectional structural view of the present invention viewed from the top.

FIG. 2 is a sectional structural view of a pipe fitting and a pipe of the present invention.

FIG. 3 is a sectional structural view of the pipe fitting of the present invention.

FIG. 4 is a bottom plan view of the present invention.

In the figures: 1—tank; 11—separation panel; 12—positioning block; 13—through holes; 14—locking groove; 15—locking blocks; 16—protrusions; 17—installation frame; 2—pipe fittings; 21—sliding groove; 22—sliding ring; 23—first transmission holes; 24—cover panel; 25—first sealing ring; 26—seond sealing ring; 27—position limiting frame; 28—second transmission holes; 3—pipe.

### DETAILED DESCRIPTION OF THE INVENTION

An embodiment of the present invention will be clearly and thoroughly described below with reference to the drawings. It should be noted that the embodiments as described is not meant to be exclusive and is only one out of different other possible embodiments. Any other embodiments which can be obtained by a person skilled in this field of art based on the embodiment described herein without the need of any inventive laboring should also fall within the scope of protection of the present invention.

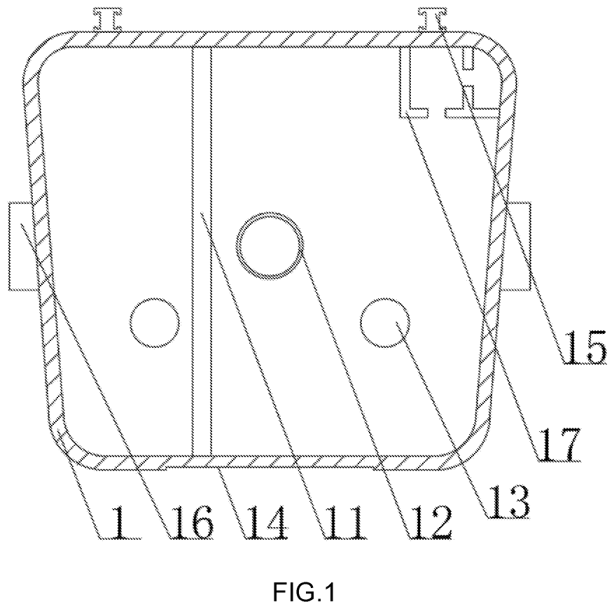

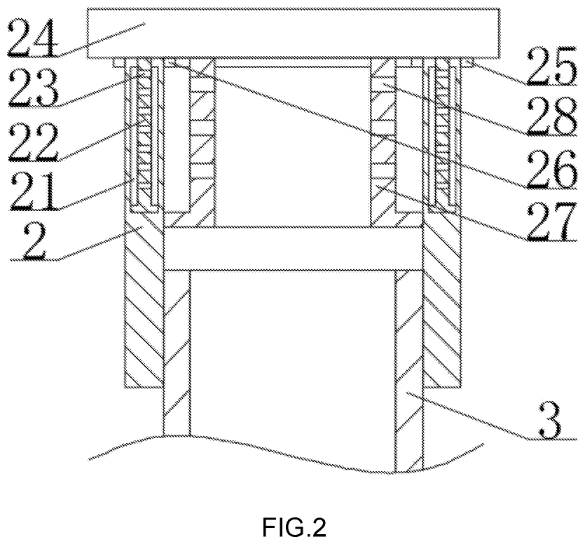

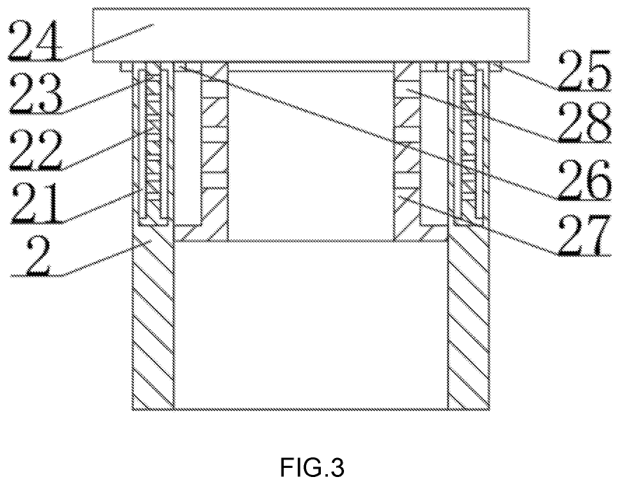

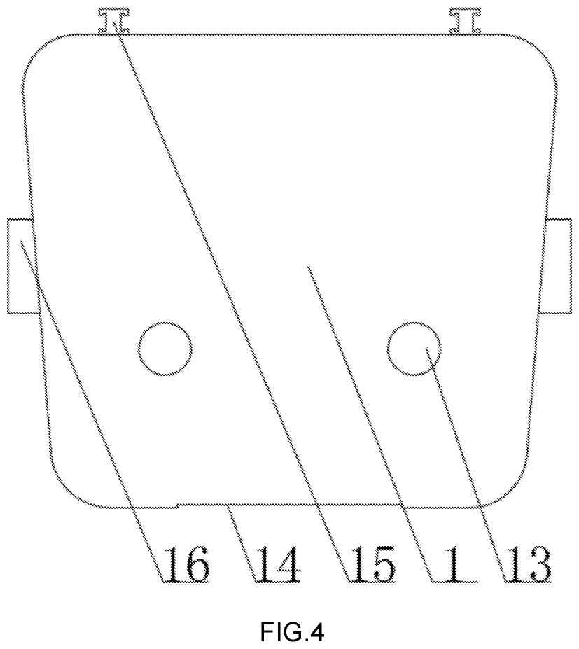

With reference to FIGS. 1-4, the present invention provides a device that prolongs service life of a filter element, comprising a tank 1 and pipe fittings 2; a separation panel 11 is provided to connect two inner opposite sides of the tank 1 by welding the separation panel to the two inner opposite sides of the tank at positions next to a middle part of a length of each of the two inner opposite sides; the separation panel 11 can effectively divide a water storage space inside the tank 1, so that unfiltered water and concentrated water stored in the tank 1 are separated, and as a result, during purification of water through an RO membrane inside a water purifier, waste water is effectively prevented from being discharged to an unfiltered water tank which otherwise will reduce service life of the RO membrane, and the RO membrane can be effectively prevented from being blocked from outputting water; therefore, the service life of the RO membrane can be further lengthened effectively. A middle part of an inner bottom surface of the tank 1 is welded with a positioning block 12; the positioning block 12 has a circular disc shape. The positioning block 12 facilitates effective installation of the tank 1 by the users. A bottom side of the tank 1 is provided with through holes 13 each corresponding to a divided water storage space divided by the separation board 11; an inner wall of each through hole 13 is welded with a corresponding pipe fitting 2; transmission and storage of water into the tank 1 is effectively achieved by the pipe fittings 2; a sliding groove 21 is provided in an interior portion of an upper part of a wall of each pipe fitting 2; and the sliding groove 21 has a central axis that coincides with a central axis of the corresponding pipe fitting; the sliding groove 21 has an annular shape; a sliding ring 22 is slidably coupled inside the sliding groove 21; a bottom end of the sliding ring 22 has an inverted T cross sectional shape; a top end of the sliding ring 22 extends out of the sliding groove 21 and is welded with a cover panel 24; the cover panel 24 is capable of sealing a corresponding pipe fitting 2; a first sealing ring 25 and a second sealing ring 26 are adhered around an inner wall and an outer wall respectively of each pipe fitting 2, and an end surface of the first sealing ring and an end surface of the second sealing ring are in contact with a bottom surface of the cover panel 24; the cover panel 24 achieves sealing of the corresponding pipe fitting 2 through the first sealing ring 25 and the second sealing ring 26; first transmission holes 23 are evenly provided around an outer peripheral surface of the sliding ring 22; the first transmission holes 23 define a honeycomb shape, so that when the cover panel 24 is disengaged from the top end of the corresponding pipe fitting 2, communication of water is achieved. A middle part of the bottom surface of the cover panel 24 is welded with a position limiting frame 27; a bottom end of the position limiting frame 27 has a L cross sectional shape; a height of the position limiting frame 27 is not shorter than a height of the sliding ring 22; the position limiting frame 27 has an annular shape; an outer periphery of the position limiting frame 27 is slidably coupled to the inner wall of the corresponding pipe fitting 2; the position limiting frame 27 can facilitate a corresponding pipe 3 to drive the cover panel 24 to move upwardly; an outer peripheral surface of the position limiting frame 27 is provided with second transmission holes 28; the second transmission holes 28 define a honeycomb shape; the second transmission holes 28 facilitate water communication between the pipe 3, the corresponding pipe fitting 2 and the tank 1; the pipe 3 is inserted into the corresponding pipe fitting 2 to facilitate transfer of water into the tank 1; a stopper is threadedly connected to a middle part of an upper surface of the tank 1 so that water inside the tank 1 can be poured out. A middle part of a front surface of the tank 1 is provided with a locking groove 14; locking blocks 15 are fixedly connected via bolts near a middle part of two opposite side edges of a rear surface of the tank respectively. A protrusion 16 is fixedly connected via a bolt at a middle part of each of the two side surfaces of the tank 1. The locking groove 14, the locking blocks 15 and the protrusions 16 facilitate installation and fixation of the tank 1. A corner of the inner bottom surface of the tank 1 is welded with an installation frame 17; an inner periphery of the installation frame 17 defines a rectangular shape; middle portions of two edges of the installation frame 17 are each provided with an opening to facilitate mounting of other fitting elements.

Working principle of the present invention: During use, the separation panel 11 disposed inside the tank 1 can effectively divide the water storage space inside the tank 1, so that unfiltered water and concentrated water stored in the tank 1 are separated, and as a result, during purification of water through an RO membrane inside a water purifier, waste water is effectively prevented from being discharged to an unfiltered water tank which otherwise will reduce service life of the RO membrane. By configuring pipe fittings 2 in the two through holes 13 of the tank 1 respectively, and by configuring the cover panel 24 on the sliding ring 22 which is slidably coupled in the sliding groove 21 of the corresponding pipe fitting 2, and by configuring the first transmission holes 23 and the second transmission holes 28 on the outer peripheral surfaces of the sliding ring 22 and the position limiting frame 27 respectively, the pipe 3 will be disengaged from a bottom end of the position limiting frame 27 inside the corresponding pipe fitting 2 when user lifts up the tank 1, so that pressure of the water inside the tank 1 will be applied to the cover panel 24 which therefore seals the corresponding pipe fitting 2 via the first sealing ring 25 and the second sealing ring 26 at the bottom surface of the cover panel 24. Accordingly, user may then take out the tank 1 entirely to pour out the water inside the tank 1.

It should be noted that, in the above description, the terms such as “first” and “second” are only intended to differentiate a feature or an operation from another feature or operation, and should not be considered claiming or suggesting any actual relationships or sequences between said features or operations. Also, terms such as “comprise”, “include” or any equivalents thereof imply non-exclusive inclusion, such that a process, method, object or equipment comprising a series of elements are not meant to comprise only said elements, but also comprise other elements not particularly specified or known elements of said process, method, object or equipment.

An embodiment of the present invention is described and illustrated above. However, a person skilled in this field of art should understand that different changes, alterations, replacements or variations will be possible provided that they are not deviated from the principle and essence of the present invention. The scope of invention is defined by the claims and their equivalent.

What is claimed is:

1. A device that prolongs service life of a filter element, comprising:
a tank; and
pipe fittings;
wherein a separation panel is provided to connect two inner opposite sides of the tank by welding the separation panel to the two inner opposite sides of the tank at positions next to a middle part of a length of each of the two inner opposite sides; a bottom side of the tank is provided with through holes each corresponding to a divided water storage space of the tank divided by the separation board; an inner wall of each through hole is welded with a corresponding pipe fitting;
a middle part of a front surface of the tank is provided with a locking groove;
locking blocks are fixedly connected via bolts near a middle part of two opposite side edges of a rear surface of the tank respectively; a protrusion is fixedly connected via a bolt at a middle part of each of the two side surfaces of the tank.

2. The device of claim 1, wherein a corner of an inner bottom surface of the tank is welded with an installation frame; an inner periphery of the installation frame defines a rectangular shape; middle portions of two edges of the installation frame are each provided with an opening.

3. The device of claim 1, wherein a middle part of an inner bottom surface of the tank is welded with a positioning block; the positioning block has a circular disc shape.

4. The device of claim 1, wherein a sliding groove is provided in an interior portion of an upper part of a wall of each pipe fitting; and the sliding groove has a central axis that coincides with a central axis of the corresponding pipe fitting; a sliding ring is slidably coupled inside the sliding groove; a bottom end of the sliding ring has an inverted T cross sectional shape; a top end of the sliding ring extends out of the sliding groove and is welded with a cover panel; first transmission holes are evenly provided around an outer peripheral surface of the sliding ring; pipes are inserted into respective pipe fittings.

5. The device of claim 4, wherein a middle part of a bottom surface of the cover panel is welded with a position limiting frame; a bottom end of the position limiting frame has a L cross sectional shape; a height of the position limiting frame is not shorter than a height of the sliding ring; the position limiting frame has an annular shape; an outer periphery of the position limiting frame is slidably coupled to an inner wall of the corresponding pipe fitting; an outer peripheral surface of the position limiting frame is provided with second transmission holes.

6. The device of claim 5, wherein a first sealing ring and a second sealing ring are adhered around the inner wall and an outer wall respectively of each pipe fitting, and an end surface of the first sealing ring and an end surface of the second sealing ring are in contact with the bottom surface of the cover panel; the first transmission holes define a honeycomb shape; the second transmission holes define a honeycomb shape.
